(19) United States
(12) Patent Application Publication
(10) Pub. No.: US 2025/0250818 A1
(43) Pub. Date: Aug. 7, 2025

(54) BRACKET ASSEMBLIES FOR ARTICULATING EXPANDABLE BARRIERS AND METHODS OF USE

(71) Applicant: Peter Zwierzykowski, San Diego, CA (US)

(72) Inventor: Peter Zwierzykowski, San Diego, CA (US)

(21) Appl. No.: 19/043,027

(22) Filed: Jan. 31, 2025

Related U.S. Application Data
(60) Provisional application No. 63/549,363, filed on Feb. 2, 2024.

(51) Int. Cl. E04H 17/18

(52) U.S. Cl. CPC E04H 17/185

(57) ABSTRACT

A bracket assembly for attaching an expandable barrier to an upright including a first mount component coupled to a second mount component forming a hinge region having a pivot axis. The first mount component is configured to couple to the expandable barrier and the second mount component is configured to couple to the upright. The pivot axis of the hinge region is off-set a distance from the upright sufficient to articulate the expandable barrier around the pivot axis from a first position in which the expandable barrier lies substantially within a plane that is parallel to a plane of a first side of the upright to a second position in which the expandable barrier lies substantially within a plane that is parallel to a plane of a second side of the upright. Related devices, systems, and methods are provided.

### CROSS-REFERENCE TO RELATED APPLICATION

This application claims the benefit of priority under 35 U.S.C. § 119e to co-pending U.S. Provisional Patent Application Ser. No. 63/549,363, filed Feb. 2, 2024. The disclosure of the provisional application is incorporated by reference in its entirety.

### FIELD

The subject matter described herein relates to expandable barriers having portions that articulate relative to one another.

### BACKGROUND

Temporary barriers are often used to delineate an area against vehicle or personal entry and incorporate lattice type structure capable of expanding and collapsing in the vertical plane. Barriers that are expandable/collapsible may also incorporate a hinge allowing for articulation of the expandable/collapsible portions relative to one another or to another structure provide more flexibility to block off a defined portion of an area, such as a portion of an aisle in a retail establishment. The expandable/collapsible portions are prone to damage if those portions are articulated around the hinge to a position that is not flush to its respective surface.

There remains a need for articulating brackets that prevent permanent damage to expandable barriers.

### SUMMARY

In an aspect, a bracket assembly for attaching an expandable barrier to an upright includes a first mount component coupled to a second mount component forming a hinge region having a pivot axis. The first mount component is configured to couple to the expandable barrier and the second mount component is configured to couple to the upright. The pivot axis of the hinge region is off-set a distance from the upright sufficient to articulate the expandable barrier around the pivot axis from a first position in which the expandable barrier lies substantially within a plane that is parallel to a plane of a first side of the upright to a second position in which the expandable barrier lies substantially within a plane that is parallel to a plane of a second side of the upright.

The first mount component can include a first vertical portion coupled to a first horizontal portion defining a first hole extending through its full thickness. The second mount component can include a second vertical portion and a second horizontal portion defining a second hole extending its full thickness. The first hole and the second hole can align to receive a pin therethrough forming the hinge region, the pivot axis extending through the pin. The second vertical portion can include surface features sized and shaped to engage the upright. The surface features project outward from a surface of the second vertical portion. The surface features are punched out and bent to project outward from the surface or the surface features are separate components that are coupled to the surface of the second vertical portion, such as by welding or another method.

The first mount component can be coupled to the second mount component to rotate less than 360 degrees around the pivot axis. The first mount component can be coupled to the second mount component to rotate greater than 0 degrees up to about 270 degrees around the pivot axis. The horizontal portion of the second mount component can incorporate a first stop on an upper surface and a second stop. The first stop abuts against an edge of the horizontal portion of the first mount component preventing rotation in a first direction around the pivot axis. The second stop abuts against a surface of the vertical portion of the first mount component preventing rotation in a second, opposite direction around the pivot axis. The first stop defines a boundary of the first articulation position that is 0 degrees around the pivot axis. The second stop defines a boundary of the final articulation position that is 270 degrees around the pivot axis.

The second mount component can be configured to couple to the upright in both an upright position and an inverted position. The bracket assembly can be part of a system further including the expandable barrier. The expandable barrier includes an expandable section coupled to an inner upright on a first side and coupled to an outer upright on a second side, and a footing on a lower end of the expandable section. The expandable section includes a multiplicity of slats hingedly interconnected in a scissoring lattice-type structure configured to expand outward from a compact, collapsed narrow configuration to an expanded, wide configuration. The multiplicity of slats can be steel or plastic. The multiplicity of slats can have a cross-sectional shape that is square, rectangular, circular, or oval.

The footing can be adjustable in height via a telescoping spring button lock mechanism. The outer upright can include a hollow receiver element including a channel extending through at least a portion of its length. The hollow receiver element can include one or more apertures through one or more walls of the receiver element into the channel. The footing can include a rod extending upwardly and configured to be received into and coupled to the lower end region of the channel in the hollow receive element of the outer upright. The footing can be coupled to the outer upright by a height adjustment feature configured to change a height of the footing relative to the outer upright. The rod can include a spring button sized and shaped to mate with and extend through the one or more apertures in the receiver element. The spring button can be biased outward to project through the one or more apertures.

### BRIEF DESCRIPTION OF THE DRAWINGS

These and other aspects will now be described in detail with reference to the following drawings. Generally speaking the figures are not to scale in absolute terms or comparatively, but are intended to be illustrative. Also, relative placement of features and elements may be modified for the purpose of illustrative clarity.

FIG. 1A is an implementation of the barrier in a collapsed configuration;

FIG. 1B is a view of a first side of a barrier as in FIG. 1A in a collapsed, articulated configuration;

FIG. 1C is a view of the barrier of FIG. 1A in an expanded, articulated configuration;

FIG. 1D is a partially exploded view of a detail of the hinge region of the barrier in FIG. 1A;

FIG. 2A is another implementation of a barrier that is not free-standing and in a collapsed configuration;

FIG. 2B is a top-down view of the barrier as in FIG. 2A illustrating a rectangular cross-sectional shape of the slats;

FIG. 2C is a top-down view of another implementation of a barrier as in FIG. 2A illustrating a square cross-sectional shape of the slats;

FIG. 2D is a detail view of an adjustment mechanism of an outer upright of a barrier;

FIG. 2E is a detail view of another adjustment mechanism of an outer upright of a barrier;

FIG. 2F is a detail view of the receiver element of the adjustment mechanism of the outer upright of FIG. 2E with the lower portion removed from the upper portion;

FIG. 2G is a view of the outer upright of a barrier;

FIG. 3A is a top end view of an implementation of a bracket assembly for a barrier;

FIG. 3B is a partial perspective view of the bracket assembly of FIG. 3A in a first position of articulation;

FIG. 3C is a partial perspective view of the bracket assembly of FIG. 3A in an intermediate articulation position;

FIG. 3D is a partial perspective view of the bracket assembly of FIG. 3A in a final position of articulation;

FIG. 4A is a partial perspective view of another implementation of a bracket assembly in a first position of articulation;

FIG. 4B is a top end view of the bracket assembly of FIG. 4A;

FIG. 4C is a top end view of the bracket assembly of FIG. 4A in a final position of articulation;

FIG. 5A is a partial perspective view of another implementation of a bracket assembly in a first position of articulation;

FIG. 5B is a top end view of the bracket assembly of FIG. 5A;

FIG. 5C is a top end view of the bracket assembly of FIG. 5A in a final position of articulation;

FIG. 6A is a perspective view of an implementation of a first mount component for a bracket assembly;

FIG. 6B is a perspective view of an implementation of a second mount component for a bracket assembly;

FIG. 6C is a perspective view of another implementation of a second mount component for a bracket assembly;

FIG. 6D is a front view of the second mount component of FIG. 6C;

FIG. 6E is a side view of the second mount component of FIG. 6C;

FIG. 7A illustrates the bracket assembly of FIG. 5A coupled to a front face of an upright by a fastener;

FIG. 7B is a cross-section through the fastener of the bracket assembly of FIG. 7A;

FIG. 8 is a front-side view of an upright showing universality of mount component coupling;

FIG. 9A is a front view of a second mount component coupled to a first mount component for a bracket assembly in a first articulation position;

FIG. 9B is a front view of the second mount component coupled to the first mount component as in FIG. 9A in a second articulation position;

FIG. 9C is a back view of the second mount component coupled to the first mount component as in FIG. 9A in the first articulation position;

FIG. 10A is a top end view of an upright and a bracket assembly without an off-set pivot axis;

FIG. 10B is a schematic showing the rotation around the pivot axis of the bracket assembly of FIG. 10A that is limited by the corner of the upright;

FIG. 10C is a top end view of an upright and a bracket assembly with an off-set pivot axis as in FIGS. 4A-4C, 5A-5C, 6A-6E, 7A-7B, 8, 9A-9C, 11A-11D, 12A-12B, 13A-13C, 14B-14C;

FIG. 10D is a schematic showing the full rotation around the pivot axis of the bracket assembly of FIG. 10C without contacting the upright;

FIGS. 11A-11D are views of a bracket assembly for a barrier;

FIGS. 12A-12B are views of a bracket assembly for a barrier;

FIG. 13A is a front view of a barrier affixed to an upright by two bracket assemblies;

FIG. 13B is a detail view of a bracket assembly affixed to an upright;

FIG. 13C is a detail view of a bracket assembly affixed to an upright in an upside-up orientation and a bracket assembly affixed to the upright in an upside-down orientation;

FIG. 14A is a front view of a barrier supported by a spacer in preparation for installation on an upright;

FIG. 14B is the gate of FIG. 14A aligned relative to upper and lower bracket assemblies affixed to the upright;

FIG. 14C is a detail view of the upper bracket assembly;

FIG. 15A is a detail assembled view of a footing of the barrier having an adjustment mechanism;

FIG. 15B is a detail exploded view of the footing of FIG. 15A;

FIG. 15C is a view of an outer upright of the barrier;

FIG. 15D is a detail view of the outer upright of FIG. 15C;

FIG. 15E is a detail view of a footing of the barrier having an adjustment mechanism;

FIG. 15F is a detail view of the footing of the barrier of FIG. 14A following extension of the footing;

FIG. 15G is a detail view of the footing of FIG. 15F illustrating spacing relative to the ground.

### DETAILED DESCRIPTION

Described herein are barriers that are temporary, expandable, and collapsible in the vertical plane that also incorporate a hinge allowing for articulation of the expandable/collapsible portions relative to an axis of the hinge, for example, relative to another barrier segment and or to a fixture providing more flexibility. The barriers described herein can be free-standing and/or coupled to a structure using a bracket assembly having an articulating coupler that prevents damage to the expandable/collapsible portions upon articulating around the hinge to a position that is flush to its respective surface.

It should be appreciated that although the barriers herein are described in the context of their use for safety, the barriers are usable for any number of purposes. In some implementations, the barriers described herein are usable for marking out a ground or floor area in which there is a safety hazard or in which maintenance or repair work is being carried out. In particular, the barriers described herein are useful in retail aisles where only a portion of the width of the aisle is barricaded and the remainder of the width of the aisle is open to the flow of traffic. The barriers described herein can be used for both outdoor applications and indoor applications. In some implementations, the barriers described herein are useful for indoor areas including residential buildings, retail buildings such as shopping malls, or warehouse “box” stores, other public venues such as maintenance locations, sporting venues, and other public venues or locations. The barriers described herein can be fully free-standing, partially free-standing, or not free-standing and designed to be attached to another fixture for support, such as a wall, door-frame, or other sort of structure that itself is free-standing.

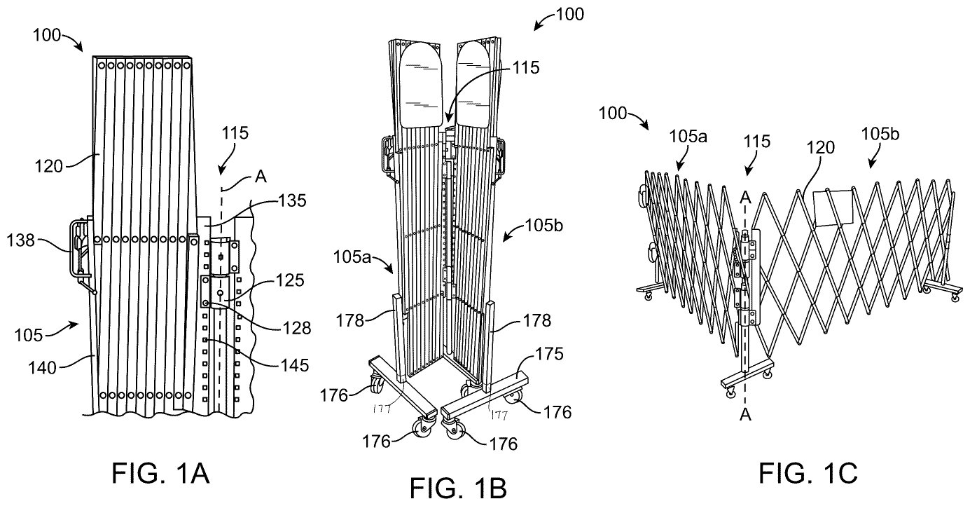

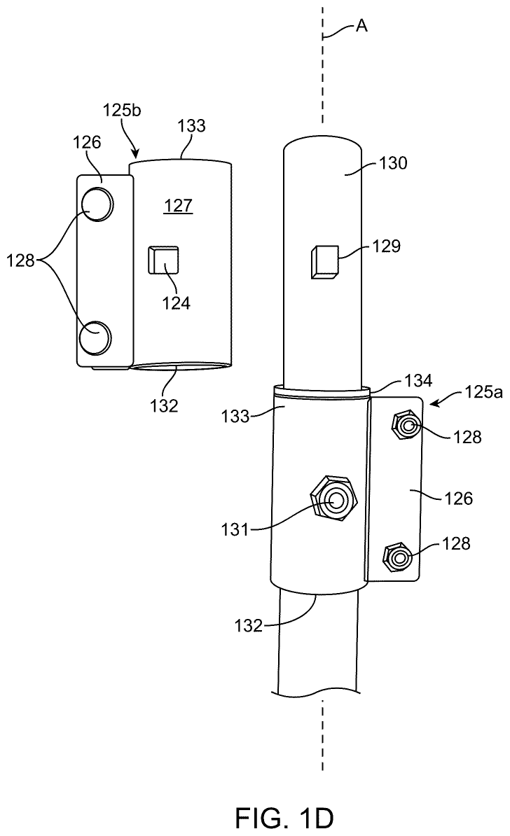

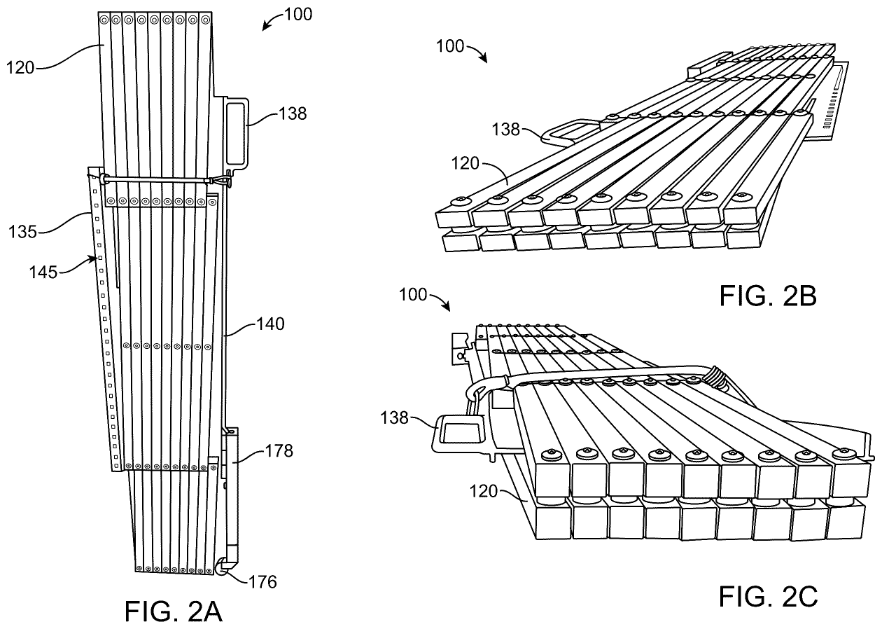

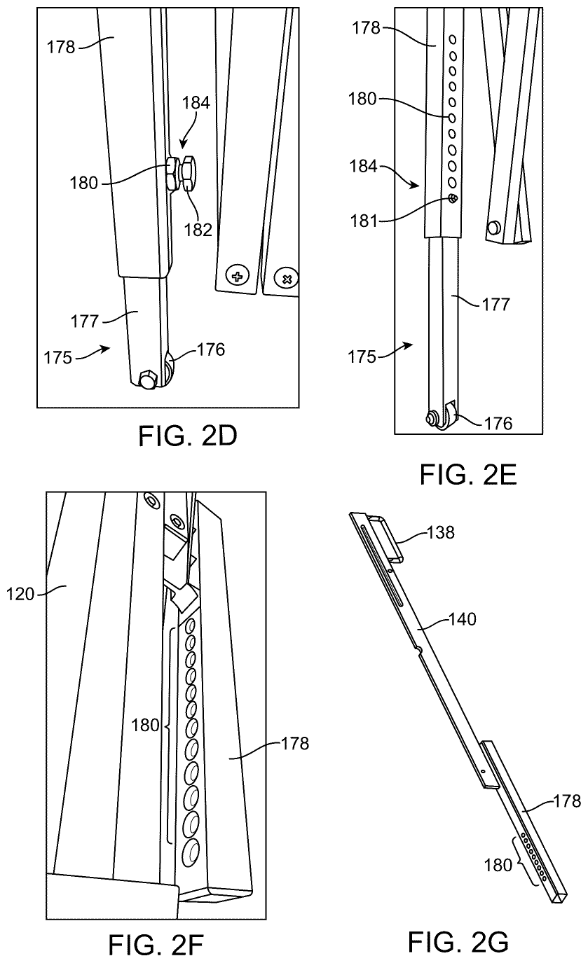

Turning to the drawings, FIGS. 1A-1C illustrate an implementation of a temporary barrier 100 incorporating at least one expandable section 105. The barrier 100 is designed so the expandable section 105 rotates around an axis A of a hinge region 115. In some implementations, the barrier 100 incorporates at least a first expandable section 105a that is coupled to at least a second expandable section 105b by the hinge region 115 allowing for the expandable sections to articulate relative to one another around the axis A (see FIGS. 1B-1C). The barrier 100 can be a free-standing barrier as shown in FIGS. 1B-IC or can be supported on at least a first end to another structure, such as by a bracket assembly 200 as shown in FIGS. 2A-2C, 3A-3D, 4A-4C, 5A-5C, 7A-7B, and also 13A-13B. Each will be described in more detail below.

A variety of expandable structure configurations are considered herein so long as the expandable sections are readily expanded outward from a compact, collapsed narrow configuration shown in FIG. 1A to an expanded, wide configuration shown in FIG. 1C. In the narrow configuration edges of the slats 120 can abut one another such that each of the slats 120 extends generally parallel to one another and perpendicular to the floor. In the expanded, wide configuration the edges of the slats 120 are separated from one another forming an open lattice structure to achieve a maximum extension. Although the barrier 100 shown in the figures incorporates an open lattice the barriers described herein can also incorporate a closed structure such that the space between the slats 120 is covered by a material such as a fabric, plastic, or other material. Also, the relative thickness of each of the slats 120 can vary providing differing degrees of privacy and protection on either side of the barrier 100. The slats 120 can have a cross-sectional shape that is rectangular or square shape that mate together upon collapse of the expandable section 105, however, other shapes are considered including round, oval, or other geometric shape. FIG. 2B is a top-down view of a barrier 100 having rectangular-shaped slats 120 whereas FIG. 2C is a top-down view of a barrier 100 having square-shaped slots 120. The barrier 100 may include at least 1, 2, or more than 2 expandable sections 105, including 3, 4, 5 or more sections configured to be pivotably attached to one another for creating an enlarged space of various geometries. The barrier can incorporate any of a number of user-friendly features including one or more signs, chains, bungie cords, and/or padlocks to maintain the collapsed configuration of the expandable section 105 when not in use.

The materials, weights, and overall size of the barrier components described herein can vary to satisfy different user preferences, such as more robust, heavy-duty metal materials such as steel for some implementations and less robust, lighter-weight, plastic materials, such as acrylonitrile butadiene styrene (ABS) or other thermoplastic polymers for other implementations. FIG. 2B illustrates a barrier having slats 120 that have a rectangular cross-sectional shape and FIG. 2C illustrates a barrier having slats 120 that have a square cross-sectional shape. The slats can have any of a variety of cross-sectional shapes including square, rectangle, circle, oval, or other geometric shape. The slats 120 of the barrier of FIG. 2B are metal, but can be plastic or another material. The slats 120 of the barrier of FIG. 2C are ABS plastic, but can be metal or another material. In some implementations, the slats 120 are one material (e.g., plastic) and the bracket assembly 200 is a different material (e.g., metal). Components such as the slats 120 (as well as the uprights and user handling components such as the handle element(s) 138) formed of plastic provides a lighter weight to the barrier, which is cheaper to manufacture and ship. The plastic also provides some flexibility to the barrier upon application of a deforming force that avoids permanently deforming the barrier damaging the expandable sections. The materials of the barrier components, such as the slats 120 can be colored orange, blue, yellow, black, gray, etc. to provide different functions.

The multiplicity of slats 120 extend between a first upright 135 and a second upright 140. The first upright 135 can couple to a first slat pair near a lower end of the first edge by a first coupling and to a second slat pair near an upper end of the first edge by a second coupling. The couplings between the slat pairs and the first upright 135 are configured to undergo scissor action, like the couplings between the slats 120 themselves. The first edge oriented towards the scissoring slats 120 can incorporate an elongated slot near the upper end within which the coupling can be received. This elongated slot allows for the coupling to slide up and down within the slot depending on expansion of the expandable section 105 such that when the expandable section 105 is in the narrow configuration, the coupling is positioned at an upper end of the slot and when the expandable section 105 is in the wide configuration, the coupling slides down away from the upper end of the slot near a lower end of the slot. A mechanism can be incorporated to limit expansion, such as a bolt or other feature. Further, the couplings described herein can vary including, but not limited to bolts, screws, pins or other mechanisms.

Again with respect to FIGS. 1A-1B and FIGS. 2A-2C, the second upright 140 can be a generally elongate element coupled to a first slat pair near a lower end by a first coupling and to a second slat pair near an upper end by a second coupling. The couplings between the slat pairs and the second upright 140 are configured to undergo scissor action. The second upright 140 can provide a surface for a user to grasp the expandable section 105 without risk of pinching their fingers when the sections 105 are expanded. The second upright 140 can incorporate one or more handle elements 138 to aid in grasping and/or expanding the sections 105 of the barrier 100.

At least a portion of the barrier 100 can incorporate a base or footing 175. The footing 175 can be coupled to lower ends of the expandable sections, such as each of the second uprights 140, to support the barrier 100 and prevent it from tipping or sagging during use. Where the barrier incorporates more than one expandable section 105, the barrier 100 can incorporate a footing 175 for the second uprights 140 of the expandable sections 105 and a footing 175 at the hinge region 115 centrally between the sections 105. Each of the footings 175 can incorporate one or more wheels 176 mounted on casters for swiveling movement to provide case of movement of the expandable sections 105, for example, during expansion of the sections 105 as well as the pivoting of the sections 105 relative to one another along any of a variety of angles (see FIG. 1C). The footing 175 can be permanently coupled to the barrier 100. The footing 175 can be removably and/or adjustably coupled to the barrier 100, for example, so that the height of the barrier 100 can be changed to accommodate different environments as described in U.S. Publication No. 2022/0251790, which is incorporated by reference herein. Each footing 175 can be in the shape of a “T” with one wheel 176 at each end of the “T” (see FIG. 1B). The “T” shaped footing 175 can be vertically adjustable relative to the uprights 140, such as with a spring button lock mechanism, as will be described in detail below.

FIGS. 2D and 2E are detail views of a footing 175 of a barrier 100 that incorporates an adjustment mechanism 184 for achieving different extension lengths of the footing 175 relative to the barrier 100. As mentioned, the barriers described herein can be fully free-standing, partially free-standing, or not free-standing and designed to be attached to another fixture for support, such as a wall, door-frame, or other sort of structure that itself is free-standing. In implementations of the barrier that are not free-standing and rely upon fixation to a structure, such as a door frame, the free end of the barrier (e.g., away from the hinge) can sag due to the weight of the barrier if the barrier segment is not supported by a footing 175 having the proper length on its outer end. Pressure applied to the barrier due to sagging can permanently warp and damage the barrier.

A rod 177 of the footing 175 can extend upwardly into a correspondingly-shaped receiver element 178 near a lower end region of the outer uprights 140 (and a lower end region of the central post 130 in the free-standing barriers). The receiver element 178 and rod 177 can couple together in a telescoping fashion so that the extension of the rod 177 relative to the receiver element 178 can be manually adjusted by a user and locked to achieve a desired position. The rod 177 can be inserted fully within the receiver element 178 up to about a location of the wheels 176 of the footing 175 to achieve the shortest telescopic position or the rod 177 can be inserted only minimally within the receiver element 178 so that the longest telescopic position of the rod 177 is achieved. The arrangement of the telescoping components (e.g., rod 177 and receiver element 178) relative to one another can vary as can the configuration of the locking adjustors to extend and retract the telescoping components. The adjustment mechanism 184 can incorporate any of a variety of locking adjustments including clutch lock, split collar lock, cam lock, spring button lock, snap lock, set knob, or combinations thereof. The height settings can be distinct including 1, 2, 3, 4, 5, 6, 7, 8, 9, 10, 11, 12 or more height settings or can be an adjustment so that a user may select any relative position between the telescoping components.

FIG. 2D illustrates an adjustment mechanism 184 in which a threaded set screw extends through the rod 177 and the receiver element 178 to fix the relative extension of the two components. The rod 177 and the receiver element 178 can include holes that upon being aligned relative to one another can receive a shaft of the set screw to fix the relative position of the receiver element 178 and the rod 177. The set screw can include an outer head 182 coupled to a threaded shaft (not visible in FIG. 2D). The threaded shaft of the set screw can be screwed into an aperture 180 in the receiver element 178 that has correspond threads so as to engage with the receiver element 178. A distal end of the threaded shaft enters a corresponding aperture (which may also be threaded) of the rod 177 to secure the inner rod 177 and the outer receiver element 178 to one another. The outer head 182 of the set screw can have a head geometry that enables manual tightening, such as with one's fingers or using a tool such as a wrench or screwdriver. In the implementation shown in FIG. 2D, the outer receiver element 178 has a single aperture to receive the shaft of the set screw and the inner rod 177 has a plurality of apertures (not visible) to receive the distal end region of the shaft of the set screw. The plurality of apertures in the rod 177 allows for the rod 177 to be telescoped further external to the receiver element 178 for a greater extension length and still be fixed relative to the receiver element 178 aperture upon alignment with one of the plurality of apertures in the rod 177 relative to the aperture of the receiver element 178. The footing of FIG. 2D is arranged so that the lower component (e.g., the rod 177) telescopes inside the upper component (e.g., the receiver element 178). A reverse arrangement is considered as well where the lower component receives the upper component inside of it so that the lower component slides over the upper component rather than within the upper component. Regardless of whether the upper component is the outer telescoping member or the inner telescoping member, the set screw can extend through an aperture in the outer component before reaching an aperture in the inner component. Both the outer component and the inner component can have a plurality of apertures so that upon aligning a pair of apertures the set screw can extend through them to fix the relative extension of the telescoping components.

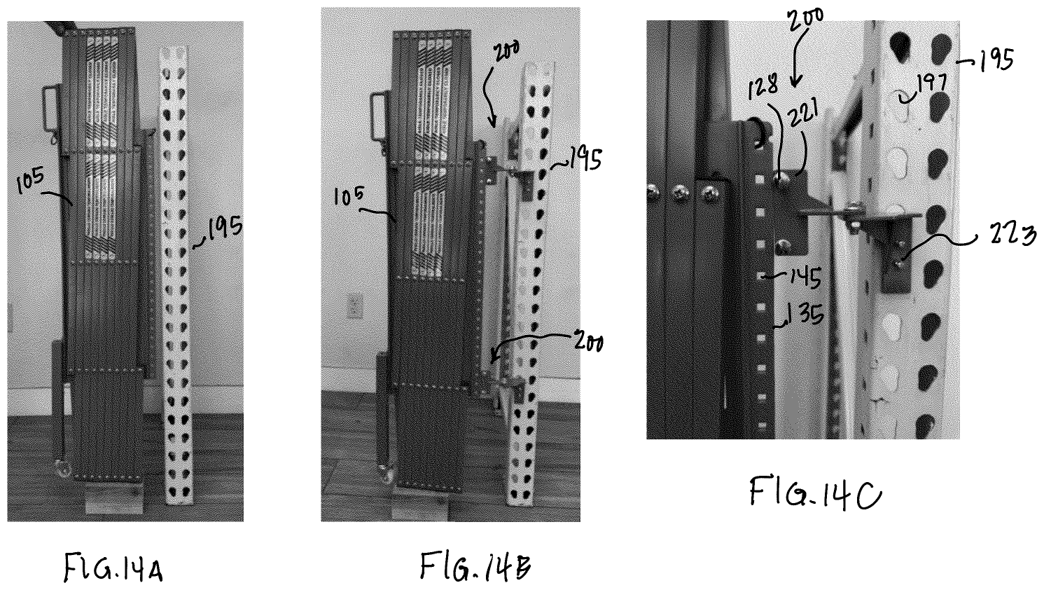

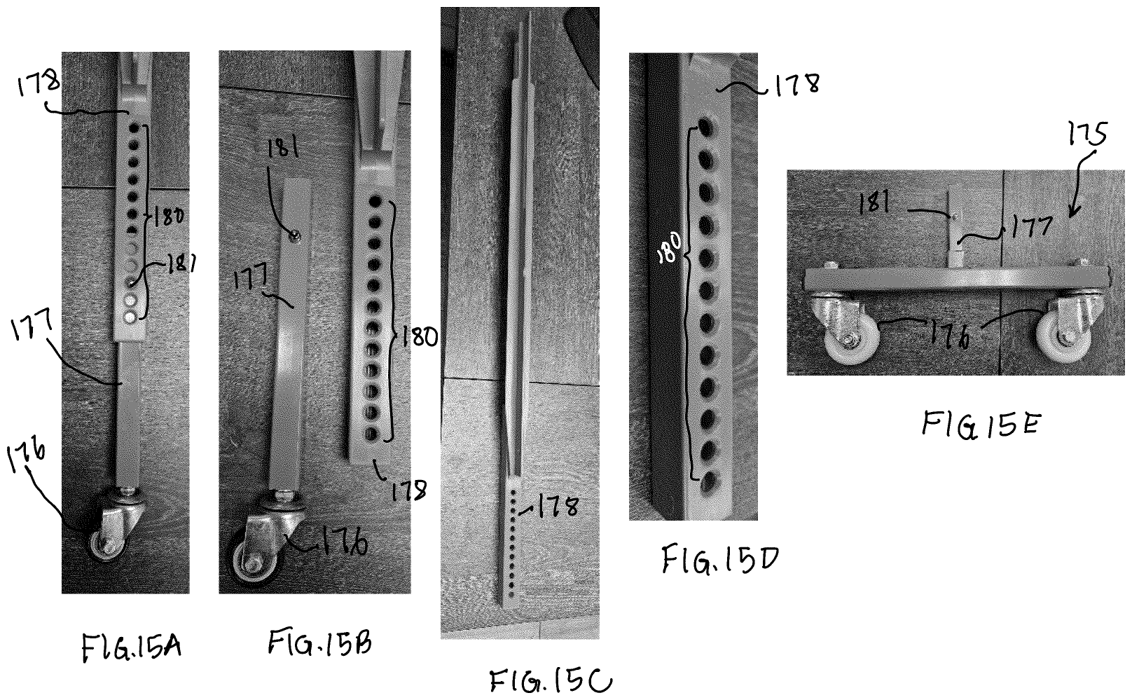

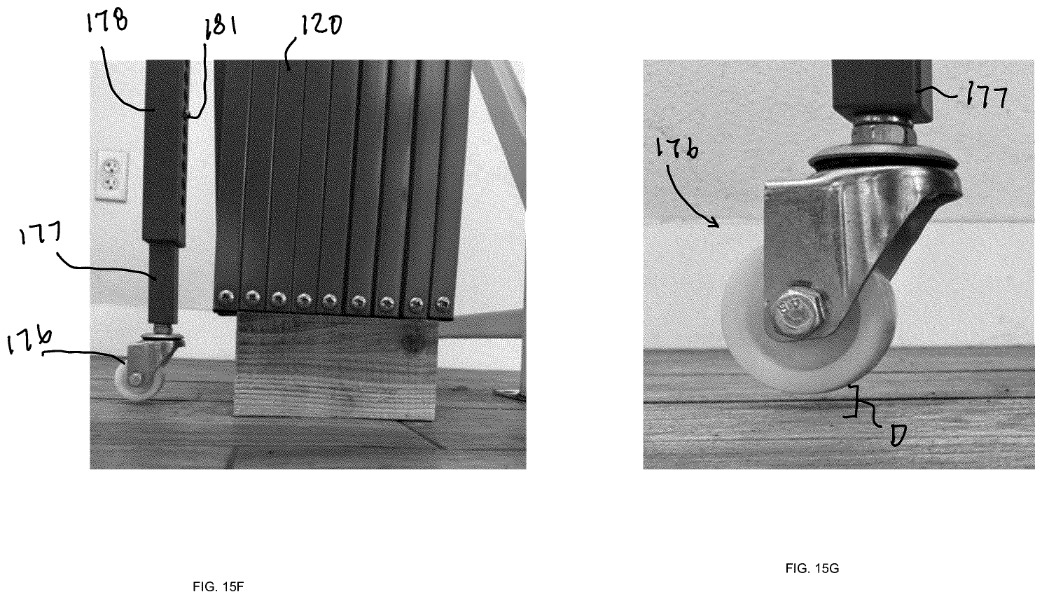

FIG. 2E and also FIGS. 15A-15E illustrates an adjustment mechanism 184 in which a spring button lock is used to fix the relative extension of the rod 177 and the receiver element 178, which can be hollow components with a channel extending through at least a portion of their lengths. FIGS. 2F, 2G, 15C, and 15D also illustrate the hollow receiver element 178 having at least one, preferably a plurality of apertures 180. The spring button lock adjustment mechanism 184 can include a pin 181 coupled to a spring (not visible in FIG. 2E) that is configured to urge the pin 181 outward relative to the telescoping component. As an example, the spring can be a clip having a central bend and the pin 181 coupled to an outer region of the clip away from the central bend. The spring can be positioned inside of the rod 177 so that the pin 181 projects outward through an aperture in the rod 177. The rod 177 includes one aperture that the pin 181 can project through although it should be appreciated that more than a single aperture is considered. The pin 181 is arranged near an upper end region of the rod 177 a distance away from the lower end where the wheels are located. As the rod 177 slides up into the receiver element 178, the pin 181 is urged inward compressing the spring. Once aligned with an aperture 180 of the receiver element 178, the pin 181 is urged by the spring to project out through the aperture in the rod 177 and through the aperture 180 of the receiver element 178. If a user desires a different relative extension, the user can press the pin 181 back through the aperture 180 so that the rod 177 can be slide further into (or out from) the receiver element 178 until a different aperture 180 aligns with the pin 181 and the pin 181 is urged by the spring to project out through the aligned apertures. Urging the rod 177 deeper into the receiver element 178 decreases the height of the footing 175 while withdrawing the rod 177 out from the channel of the receiver element 178 increases the height of the footing 175. The spacing and number of the apertures 180 allows for a variety of discrete heights to be manually selected. For example, the receiver element 178 can include 12 apertures 180 arranged along its length. The rod 177 can incorporate a single pin 181 near an upper end region of the rod 177 that projects outward from the rod 177. When the rod 177 first inserts into the receiver element 178, the 1^{st} aperture 180 of the 12 apertures 180 can allow the pin 181 to project out through it resulting in the greatest length for the rod 177 and the receiver element 178. The pin 181 can be urged back inside the rod 177 by a user pinching the pin 181 so that the rod 177 slides up further into the receiver element 178. Once the rod 177 is fully inserted into the receiver element 178, the pin 181 can project out through the 12^{th} aperture 180 of the 12 apertures 180 resulting in the shortest length of the rod 177 and the receiver element 178. Each aperture 180 can have a beveled or chamfered edge for user comfort allowing a user to apply pressure more easily on the pin 181 to urge it back through the apertures 180. The rod 177 and receiver element 178 can be captive so that they do not fully separate from one another. Alternatively, the rod 177 and receiver element 178 can be fully removed from one another.

The footing 175 of FIG. 2E (and also FIGS. 15A-15E) is arranged so that the lower component (e.g., the rod 177) telescopes inside the upper component (e.g., the receiver element 178) and the upper component has a plurality of apertures 180 through which the pin 181 of the lower component can project. A reverse arrangement is considered as well where the lower component receives the upper component inside of it so that the lower component slides over the upper component rather than within the upper component. In this arrangement, the lower component sliding over the upper component would have the plurality of apertures 180 and the upper component sliding inside the lower component would have the spring lock button. Regardless of whether the upper component is the outer telescoping member or the inner telescoping member, the pin 181 can extend through an aperture 180 in the inner component before reaching an aperture in the outer component. Both the outer component and the inner component can have a plurality of apertures so that upon aligning a pair of apertures, the pin 181 can extend through them to fix the relative extension of the telescoping components.

The height adjustment mechanism 184 of the gate segment ensures pivoting around the axis of the hinge without causing damage. The adjustment mechanism 184 in which a spring button lock is used to fix the relative extension of the rod 177 to the receiver element 178 provides distinct advantages over the screw. The screw, which relies upon threaded engagement, can loosen over time resulting in the lower rod 177 loosening within the upper receiver element 178. This can cause sagging of the leg relative to the hinge leading to gate damage or difficulty in moving the gate around its pivot axis. The screw can be manually tightened to fix the adjusted height, but this requires tools and/or can be difficult for some users to adjust when desired. The spring button lock adjustment mechanism 184 provides stable, long-term fixation of the rod height without the need for tools to tighten and/or loosen.

As discussed above, the footing 175 of the barrier 100 can incorporate one or more wheels 176 providing case of movement of the expandable sections 105 around the pivot axis. The wheels 176 shown, for example, in FIG. 1B and also FIGS. 15A-15B, 15E, and 15F-15G are mounted on casters that allow for 360 degrees swiveling movement such that the wheels 176 can be directed in any of a variety of directions. In some implementations, the wheels 176 are mounted by an axle that extends through a lower end of the rod 177 and is fixed relative to the expandable section 105 of the barrier 100 (see FIG. 2E). The axle is mounted orthogonal to the vertical plane of its expandable section 105 so that as the expandable section 105 enlarges or contracts, the wheel 176 rotates around the axle, either forward or backward. The wheels 176 mounted on a fixed axle thus, provides guidance for expansion of the barrier 100 in the single vertical plane of the expandable section 105.

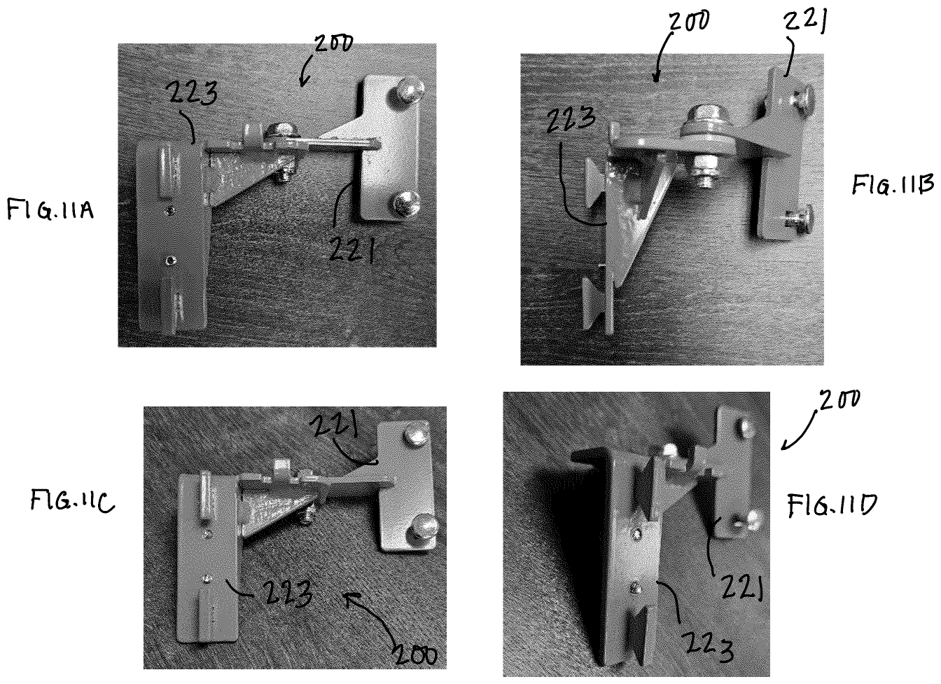

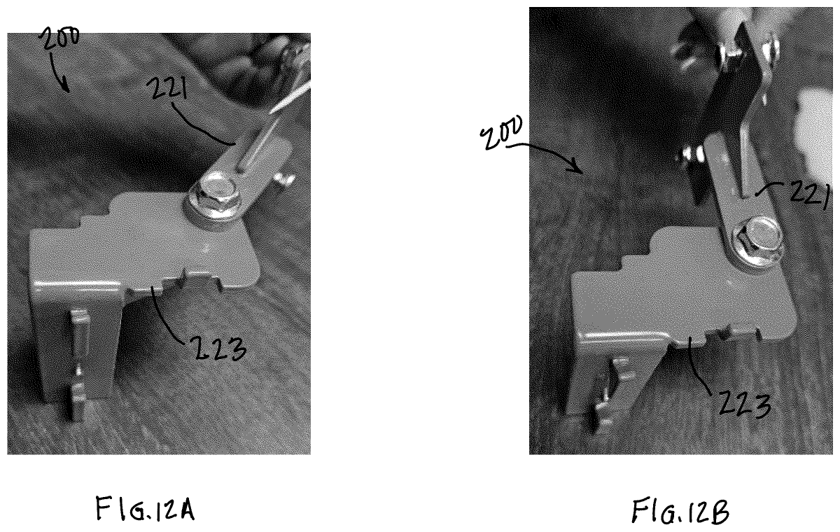

The barrier 100 with the telescopic footings can be free-standing as shown in FIGS. 1B-1C or can be attached and supported on at least a first end to another structure, such as a wall, doorframe, garage, entryway, porch, shelving, and the like, by a bracket assembly 200 (see FIGS. 2A-2C, 3A-3D, 4A-4C, 5A-5C, 6A-6B, 9A-9C, 11A-11D, 12A-12B, 13A-13C, 14A-14C). The bracket assembly 200 can attach the uprights 135, 140 of the barrier 100 to an upright 195 of the bracket assembly 200 or other similar element located in the environment within which the barrier 100 is to be used so that the expandable section 105 can rotate about the upright 195 forming various articulation angles, which will be described in detail below.

As mentioned, the barrier 100 can include an expandable section 105 having a multiplicity of slats 120 that extend between a first upright 135 and a second upright 140. A first expandable section 105 can articulate relative to a second expandable section (or another component as in the case of a non-free-standing barrier) around the hinge region 115 axis of rotation A forming an articulation angle. A first hinge element can be formed near a lower end of the barrier 100 and a second hinge element formed near an upper end of the barrier 100. FIG. 1D is an exploded view of a hinge element incorporating first and second connectors 125a, 125b configured to engage a region of a cylindrical post 130. The connector 125a of a first expandable section 105a can be positioned on the post 130 such that its lower edge 132 is adjacent an upper edge 133 of the connector 125b of the second expandable section 105b forming an articulating hinge element near a lower end region of the barrier 100. Another connector 125a of the first expandable section 105a can be positioned on the post 130 such that its upper edge 133 is adjacent a lower edge 132 of the connector 125b of the second expandable section 105b forming an articulating hinge element near an upper end region of the barrier 100. In other implementations, the connectors 125a of the first expandable section 105a interdigitate with the connectors 125b of the second expandable section 105b. It should be appreciated that the relative number and arrangement of connectors 125 can vary. It should be appreciated that although the hinge region 115 is described as having a particular mechanical configuration herein that other configurations of hinges are considered herein including, but not limited to a barrel hinge, butt hinge, flush hinge, continuous hinge, piano hinge, etc.

Still with respect to FIG. 1D, each connector 125 can be a generally tubular structure having a leaf 126 extending outward laterally from a knuckle 127. The leaf 126 of the connector 125 is configured to couple with the expandable section 105 and the tubular knuckle 127 is configured to couple with the post 130. The inner cylindrical surface of the tubular knuckle 127 has an inner diameter sized to receive an outer diameter of the outer cylindrical surface of the post 130 such that the tubular knuckle 127 can be received over the post 130 and the connectors 125 and the post 130 are coaxially aligned. The tolerance between the inner surface or inner diameter of the tubular knuckle 127 and outer surface or outer diameter of the post 130 is such that the connector 125 is readily pivotable relative to the post 130, but not too loose to affect a smooth articulating movement around the axis of rotation A. At least one or both of the connectors 125a, 125b can be moveably coupled to the post 130 such that at least one or both of the expandable sections 105a, 105b can rotate about the post 130 forming various articulation angles relative to one another. In some implementations, the tubular knuckle 127 of a first connector 125a is fixedly attached to the post 130 such that it does not rotate relative to the post 130 whereas the tubular knuckle 127 of a second connector 125b is rotatably attached to the post 130. For example, as shown in FIG. 1D, connector 125b inserted over the post 130 is configured to rotate relative to the post 130 whereas connector 125a inserted over the post 130 is configured to fixedly attach to the post 130 by a bolt 131 or other coupling element such that it does not rotate relative to the post 130. Further, the adjacent edges of the connectors 125 forming each hinge element can incorporate a coating or covering allowing for smooth pivoting movements between them. Alternatively, a washer 134 or other element between the connectors 125 can be incorporated into the hinge elements for smooth pivoting movements of the expandable sections.

Each of the connectors 125 also includes a connection leaf 126 configured to couple with its respective expandable section 105. The connection leaf 126 can be an outwardly-extending planar portion having at least one aperture extending through it. As mentioned previously, each expandable section 105a, 105b includes a multiplicity of slats 120 that extend between an inner upright 135 and an outer upright 140. The inner upright 135 can be a generally rectangular, planar piece having a first elongate edge oriented towards and moveably coupled to the scissoring slats 120 and a second elongate edge oriented towards the central post 130 and having a plurality of openings 145. When the tubular knuckle 127 of the connector 125 is positioned over the central post 130, the at least one aperture extending through the connection leaf 126 aligns with an opening 145 of the inner upright 135 such that a coupling element 128 can be received therethrough. The coupling element 128 can be a rivet, screw, bolt, or other component configured to clamp the connector 125 to its respective expandable section 105. In some implementations, the opposing flanges each have two apertures configured to receive two coupling elements 128.

The barrier 100 can incorporate a hinge lock. The hinge lock can maintain the two expandable sections 105a, 105b aligned within a single vertical plane. The hinge lock can engage a portion of the inner uprights 135 of each of the sections 105a, 105b locking them into fixed relative position and preventing articulation around the axis of rotation of the hinge region 115 as described in U.S. Pat. No. 10,472,883, which is incorporated herein. The coupling between the post 130 and the connector 125 can form an actuatable hinge lock that allows a user to quickly and easily unlock the expandable sections 105a, 105b so that they may articulate relative to one another, such as via a spring button 129 sized to insert through a corresponding aperture 124 in knuckle 127, as shown in FIG. 1D and described in U.S. Publication No. 2022/0251790, which is incorporated by reference herein. The spring button 129 can have any of a variety of shapes sized to extend through a correspondingly-sized aperture 124. The spring button 129 can be rounded or circular or be more angular in shape (e.g., rectangular or square as shown in the figure). The aperture 124 sized to receive the spring button 129 can be similarly shaped or have a different shape (e.g., aperture 124 is square and the spring button 129 is rounded).

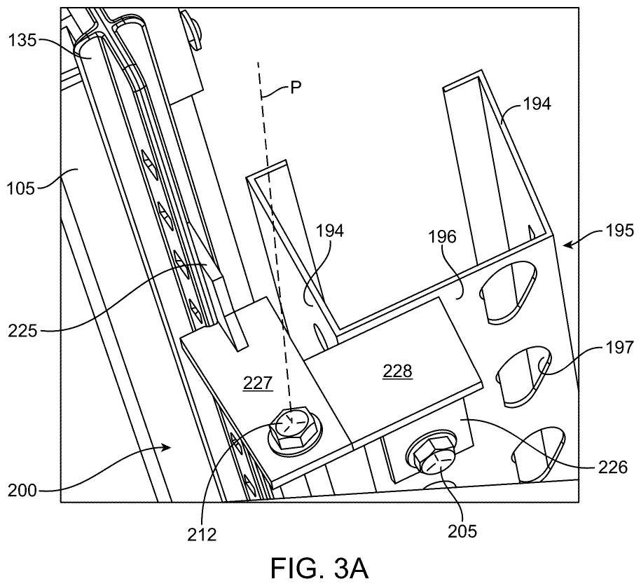

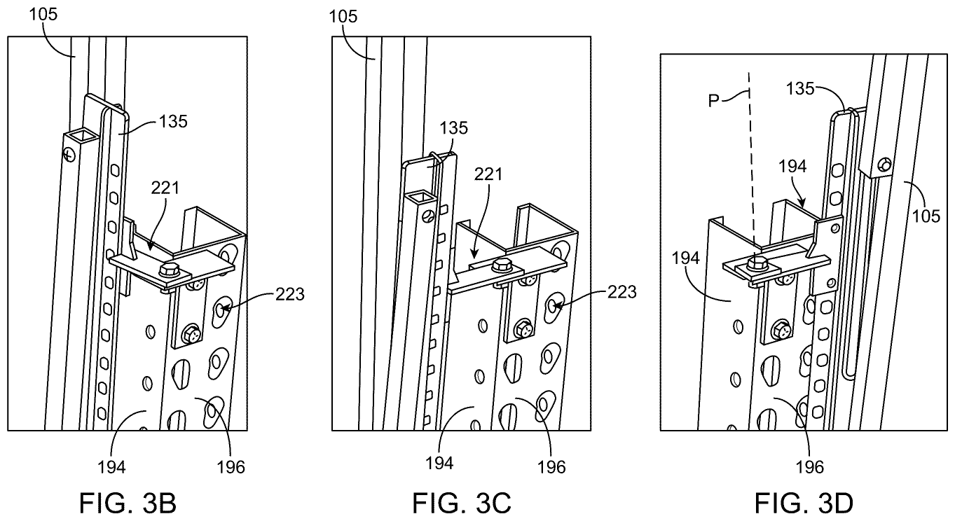

As mentioned above, at least one of the first and second uprights 135, 140 is coupled to a structure where the barrier 100 is intended to be used. The expandable section 105 can be coupled to another expandable section 105 or to a structure in an environment in which it will be used in a manner that allows for rotation of the expandable section 105 around an axis. Alternatively, both uprights 135, 140 can be attached to structures. The barrier 100 can be coupled to the structure via a bracket assembly 200. FIG. 3A is a top end view of an implementation of a bracket assembly 200 connecting an upright 135 of a barrier 100 to an upright 195. The bracket assembly 200 can connect the barrier 100 to the upright 195 such that the expandable section 105 of the barrier 100 can rotate about axis P forming various articulation angles. The bracket assembly 200 can incorporate a first mount component 221 coupled to a second mount component 223 by a pin 212 forming a hinge region 220 having a pivot axis P. Each of the components of the bracket assembly 200 will be described in more detail below.

FIGS. 3A-3D illustrate an implementation of an upright 195. The upright 195 can be affixed to a structure, such as a wall, doorframe, shelving, or other feature. The environment that the barrier 100 is to be used will determine what sort of structure the upright 195 is affixed to. The upright 195 configuration can vary. In the implementation of FIGS. 3A-3D, the upright 195 incorporates two sides 194 and a front face 196. The sides 194 can be fixed to a structure leaving the front face 196 free to couple to a bracket assembly 200. At least the front face 196 can include a column of holes 197 for coupling to the bracket assembly 200. The front face 196 of FIG. 3A has a left-side column of holes 197 and a right-side column of holes 197. Each of the holes 197 can be teardrop shaped having an enlarged upper end compared to a smaller lower end.

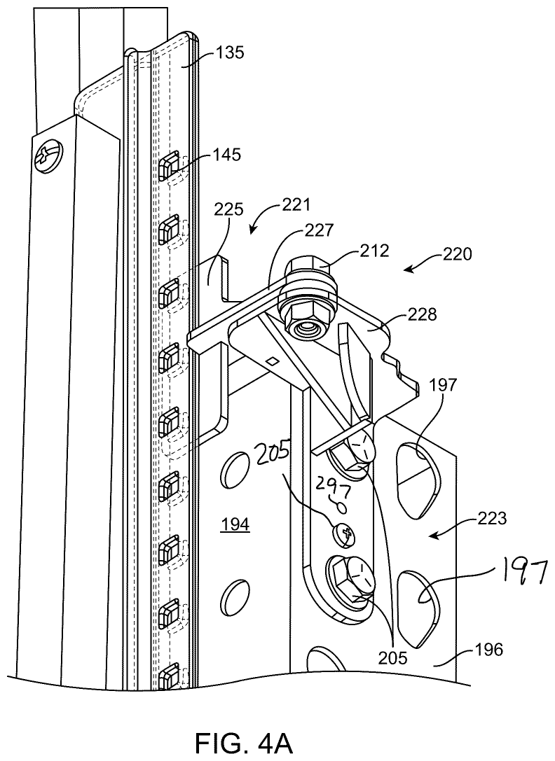

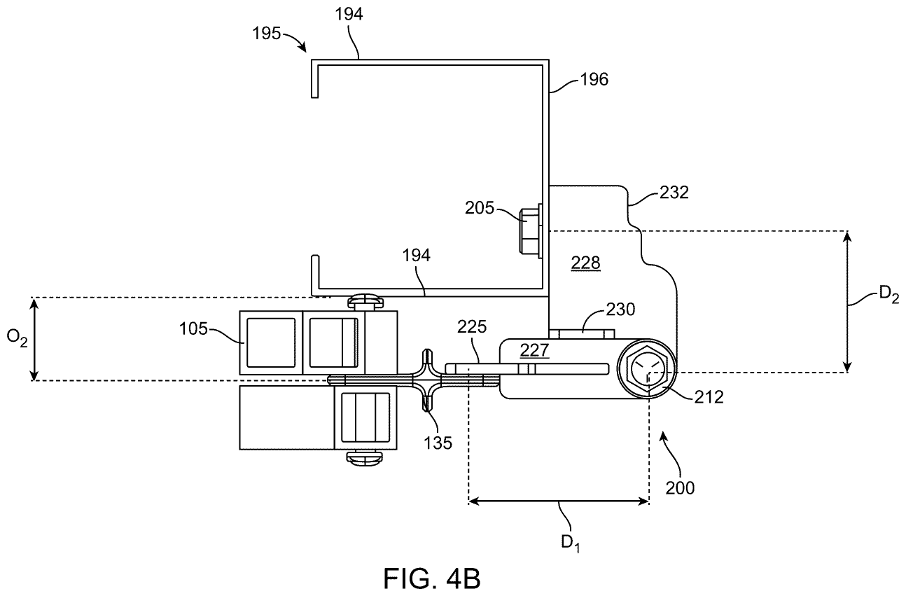

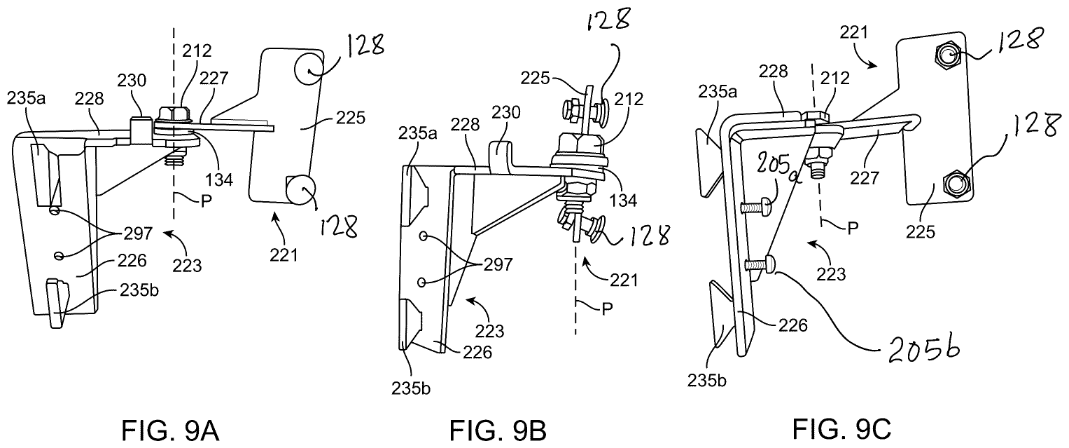

The bracket assembly 200 can incorporate a first mount component 221 configured to be attached to one of the uprights 135 of the barrier 100 and a second mount component 223 configured to be attached to the upright 195 (see FIGS. 3B-3D). The first mount component 221 and the second mount component 223 are connected to one another forming a hinge element 220 so that the two components 221, 223 can pivot around pivot axis P. The first mount component 221 has a vertical portion 225 and a horizontal portion 227 (see FIGS. 3A and 6A, 9A-9C, and also 11A-11D and 12A-12B). The second mount component 223 also has a vertical portion 226 and a horizontal portion 228 (see FIGS. 3A and 6B, 9A-9C, and also 11A-11D and 12A-12B). The horizontal portion 227 of the first mount component 221 includes a hole 213 and the horizontal portion 228 of the second mount component 223 includes a hole 214 that when aligned with the hole 213 forms a bore sized to receive a pin 212 (see FIGS. 3A, 9A-9C, and also 11A-11D and 12A-12B). The pin 212 can be a bolt configured to extend through the bore and fastened relative to the horizontal portions 227, 228 with a nut. The hinge element 210 can incorporate a washer 134 between the horizontal portions 227, 228 to improve articulation around the pivot axis P (see FIGS. 4A and 5A, 9A-9C, and also 11A-11D and 12A-12B).

Again with regard to FIGS. 3B-3D, the bracket assembly 200 can articulate around the pivot axis P from a first position of articulation, through an intermediate articulation position, to a final position of articulation. FIG. 3B shows the first mount component 221 coupled to the upright 135 and the second mount component 223 coupled to the front face 196 of the upright 195. FIG. 3B shows the first mount component 221 in a first position of articulation around the pivot axis P so that the upright 135 of the expandable section 105 of the barrier 100 extends generally perpendicular to a plane of the front face 196 of the upright 195. The horizontal portion 227 of the first mount component 221 is also arranged substantially perpendicular to the horizontal portion 228 of the second mount component 223. FIG. 3C shows the first mount component 221 in an intermediate articulation position rotated about 90 degrees around pivot axis P compared to its position in FIG. 3B so that the upright 135 of the expandable section 105 of the barrier 100 extends generally within a plane that is parallel to a plane of the front face 196 of the upright 195. The horizontal portions 227, 228, of the first and second mount components 221, 223 are arranged substantially parallel to one another. FIG. 3D shows the first mount component 221 in a final position of articulation about 270 degrees around pivot axis P compared to FIG. 3B and about 180 degrees around pivot axis P compared to FIG. 3C so that the upright 135 of the expandable section 105 of the barrier 100 extends generally within a plane that is parallel to a plane of the front face 196 of the upright 195. The horizontal portions 227, 228 of the first and second mount components 221, 223 are completely folded over relative to one another and once again arranged substantially parallel to one another.

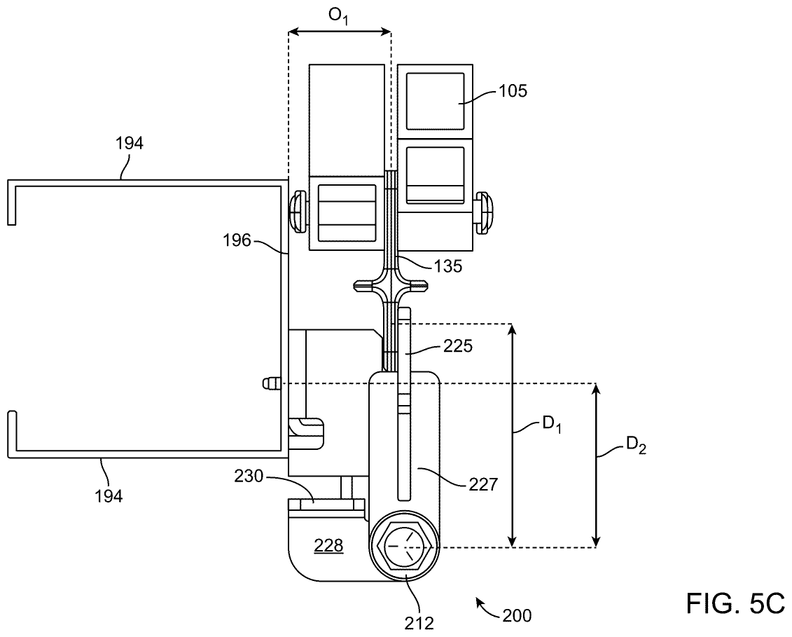

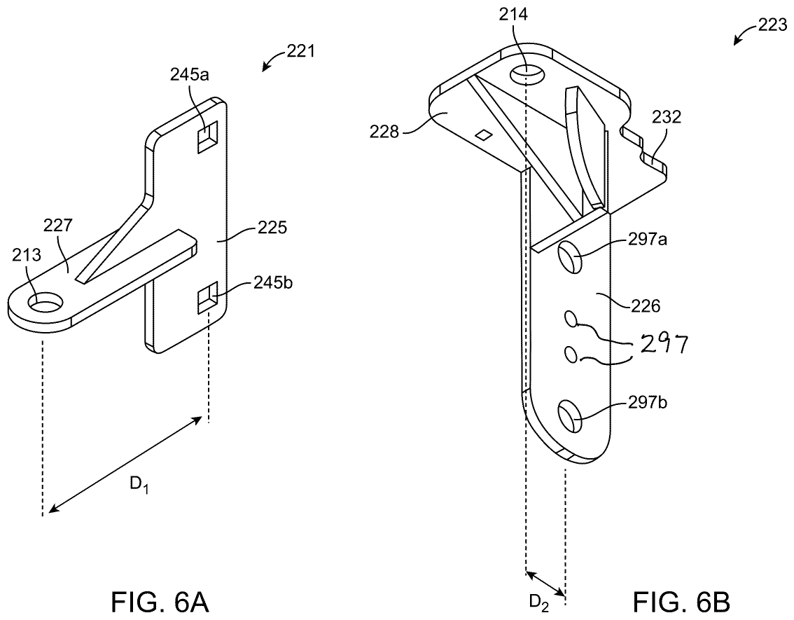

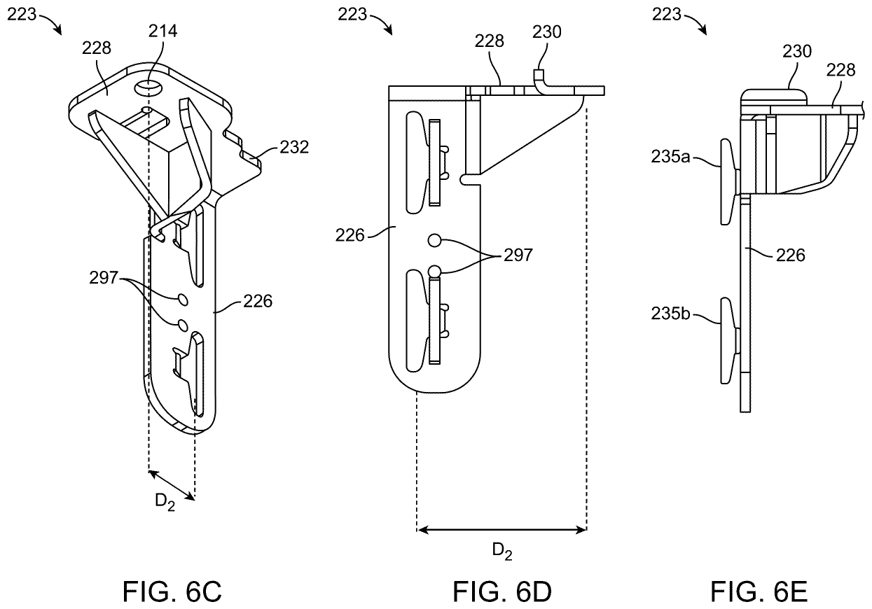

The first and second mount components 221, 223 are coupled together so that the maximum rotation around pivot axis P is less than 360 degrees, preferably 270 degrees. The horizontal portion 228 of the second mount component 223 can incorporate a first stop 230 on an upper surface (see FIGS. 6D-6E and 9A-9B) and a second stop 232 (see FIG. 6C) that together control the amount of rotation the first mount component 221 can pivot around pivot axis P relative to the second mount component 223. The first stop 230 can project above the upper surface of the horizontal portion 228 of the second mount component 223. An edge of the horizontal portion 227 of the first mount component 221 abuts against the first stop 230 in the first articulation position preventing the first mount component 221 from rotating any further over the upper surface of the horizontal portion 228. Thus, the first stop 230 defines 0 degrees around the pivot axis P. When in the first position of articulation, the horizontal portion 227 of the first mount component 221 can only rotate around the pivot axis P away from the first stop 230. When in the final position of articulation, the second stop 232 of the horizontal portion 228 of the second mount component 223 abuts against a surface of the vertical portion 225 of the first mount component 221 preventing the first mount component 221 from rotating any further in that direction relative to the second mount component 223 around pivot axis P.

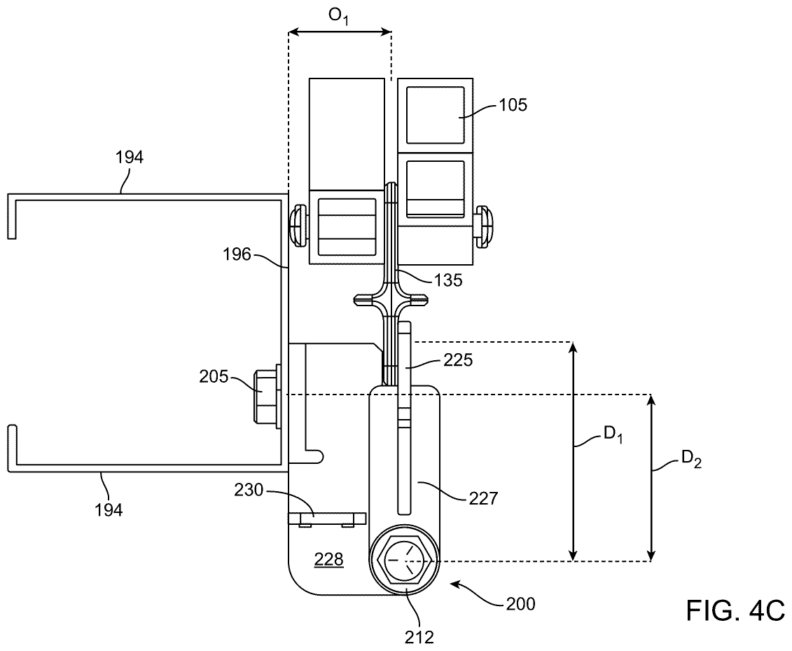

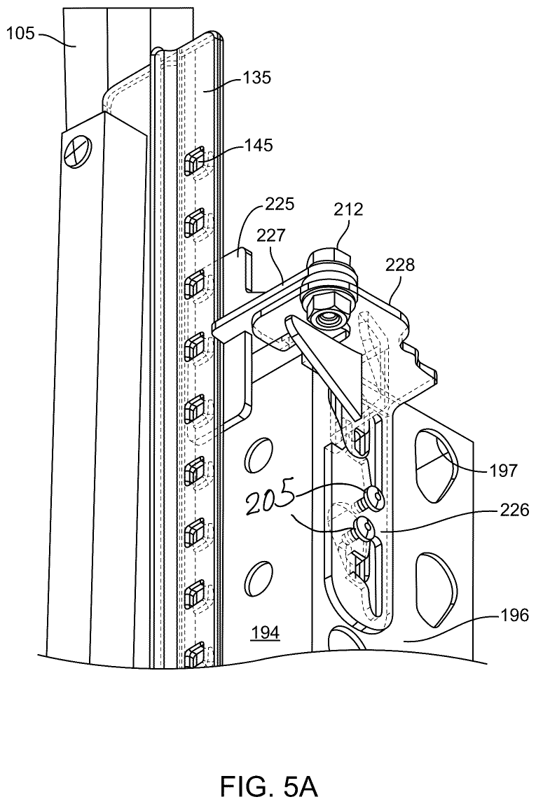

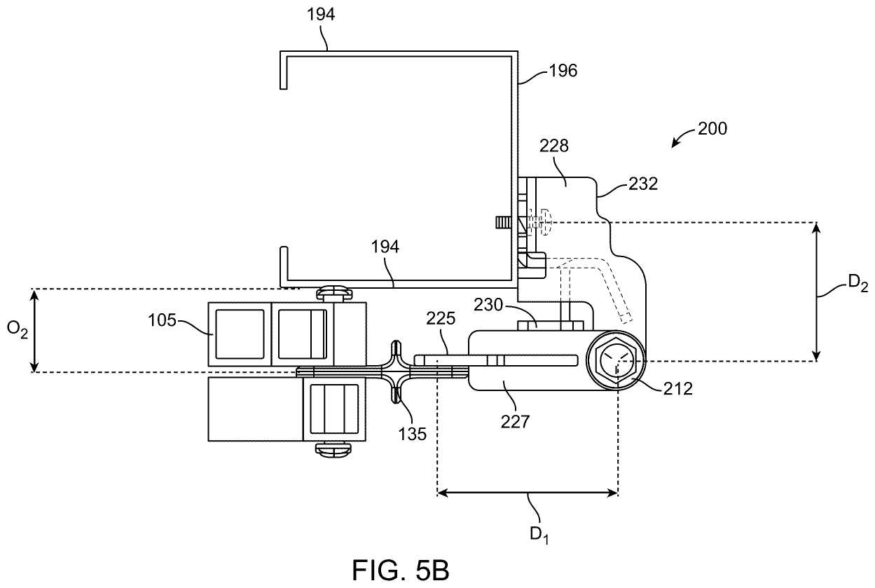

FIG. 4A is a partial perspective view of an implementation of a bracket assembly 200. FIG. 4B is a top end view of the bracket assembly 200 of FIG. 4A in the first position of articulation and FIG. 4C is a top end view of the bracket assembly of FIG. 4A in the final position of articulation. FIG. 5A is a partial perspective view of another implementation of a bracket assembly 200. FIG. 5B is a top end view of the bracket assembly 200 of FIG. 5A in the first position of articulation and FIG. 5C is a top end view of the bracket assembly of FIG. 5A in the final position of articulation.

The pivot axis P in the implementations of FIGS. 4A-4C and FIGS. 5A-5C is off-set a distance from the side 194 of the upright 195 compared to the location of the pivot axis P in the implementation of FIGS. 3A-3D. For example, FIGS. 4B-4C and also FIGS. 5B-5C show the distance D₁ between the pivot axis P and the fixation point of the vertical portion 225 of the first component 221 to the upright 135 of the expandable section 105 of the barrier. FIGS. 4B-4C and also FIGS. 5B-5C also show the distance D₂ between the pivot axis P and the fixation point of the vertical portion 226 of the second component 223 to the front face 196 of the upright 195. Distance D₁ provides for off-set O₁ from the front face 196 of upright 195 and distance D₂ provides for off-set O₂ from the side 194 of upright 195. The off-set O₁ allows for the expandable section 105 of the barrier 100 to lie flush within a plane that is parallel to the plane of the side 194 of the upright 195 when in the first articulation position as shown in FIGS. 4B and 5B. The off-set O₂ allows for the expandable section 105 of the barrier 100 to lie flush within a plane that is parallel to the plane of the front face 196 of the upright 195 when in the final articulation position as shown in FIGS. 4C and 5C. The flush alignment with the planes of the upright 195, whether the side 194 or the front face 196, prevents inadvertent deformation of the expandable sections 105 of the barrier that can damage the expandable slats 120 and prevent their subsequent expansion and collapse. For example, if in the final articulated position over the front face 196 of the upright and the expandable section 105 of the barrier 100 is not substantially flush relative to the face 196, pressing against the expandable section 105, such as inadvertently with a forklift, could urge the expandable section 105 further around the pivot axis P towards the face 196 causing the slats 120 to bend. In the case of metal slats 120, the bend can become permanent, which impairs proper expansion and collapse of the slats 120. The pivot axis P of the hinge region provided by the bracket assemblies described herein is off-set from the upright 195 a sufficient distance due to the distances D₁ and D₂ so the barrier 100 coupled to the mount components 221, 223 can lie within its plane without distortion or deformation. The stops at 0 degrees and 270 degrees guide the articulation around pivot axis P so that the expandable section 105 of the barrier 100 lies substantially flush within a first plane that is parallel to a plane of the side 194 of the upright 195 in the first articulation position and lies flush within a second plane that is parallel to a plane of the front face 196 of the upright 195 in the final articulation position.

FIG. 6A, FIGS. 9A-9C, and also 11A-11D and 12A-12B show the first mount component 221 of a bracket assembly 200 according to an implementation. FIG. 6B, FIGS. 9A-9C, and also 11A-11D and 12A-12B show the second mount component 223 of a bracket assembly 200 according to an implementation that is configured to couple to the first mount component 221. FIG. 9A-9C show the mount components 221 and 223 coupled together via pin 212. FIG. 9A illustrates a first degree of rotation of the first mount component 221 relative to the second mount component 223 around pivot axis P. FIG. 9B illustrates a second degree of rotation (about 90 degrees relative to rotation shown in FIG. 9A) of the first mount component 221 relative to the second mount component 223 around pivot axis P. FIG. 9C shows an opposite side of the mount components 221 and 223 of FIG. 9A. As discussed above, the first mount component 221 has a vertical portion 225 and a horizontal portion 227. The vertical portion 225 of the first mount component 221 can include at least one connecting feature that is configured to be engaged with a portion of the barrier 100, such as one of the uprights 135, 140. For example, the connecting feature on the first mount component 221 can include one or more holes 245 that, when aligned with corresponding holes 145 in the upright 135, can receive a fastener therethrough. The vertical portion 225 of the first mount component 221 is shaped and arranged to lie substantially flush with a corresponding surface of the upright 135, 140 to which it attaches so that the holes 245, 145 can align forming a single bore through which the fastener extends. FIG. 6A shows a first hole 245a through an upper end of the vertical portion 225 and a second hole 245b through a lower end of the vertical portion 225. The holes 245a, 245b are spaced to align with corresponding holes 145 and each receives a fastener. FIGS. 9A-9C illustrate fasteners extending through the holes.

FIG. 6B shows the second mount component 223 of a bracket assembly 200 according to an implementation having a vertical portion 226 and a horizontal portion 228. The vertical portion 226 of the second mount component 223 can include at least one connecting feature that is configured to be engaged with a portion of the upright 195. For example, the connecting feature on the second mount component 223 can include one or more holes 297 that, when aligned with at least a corresponding hole 197 in the upright 195, can receive a fastener 128 therethrough. The vertical portion 226 of the second mount component 223 with the hole 297 is shaped and arranged to lie substantially flush with a corresponding surface 196 of the upright 195 to which it attaches so that the holes 297, 197 can align forming a single bore through which a fastener extends. FIG. 6B shows a first hole 297a through an upper end of the vertical portion 226 and a second hole 297b through a lower end of the vertical portion 226. The fasteners described herein, such as fastener 205 shown in FIGS. 3A-3D, FIGS. 4A-4C, FIGS. 5A-5C, can incorporate features that are configured to engage and dig into the metal surrounding the holes of the bracket assembly 200 to further fixate the fastener to the bracket assembly 200 upon tightening.

The connection feature on the second mount component 223 need not be holes as shown in the embodiment of FIG. 6B that are configured to receive fasteners like fastener 205 therethrough to couple with the upright 195. The connection feature can include surface features 235, such as hooks punched out of the component and/or welded onto the component, that are sized and shaped to project outward from a back surface of the vertical portion 226 (see FIGS. 6C-6E and 9A-9C). The surface features 235 can have any of a variety of shape that enables them to be inserted through holes 197 in an upright 195 and provide reversible fixation of the bracket component. The surface features 235 can have a shape resembling a screw, button, a pyramid, or triangular or winged shape. The surface feature 235 can have a narrower dimension portion nearest the vertical portion 226 and a wider dimension portion furthest away from the vertical portion 226. As mentioned herein, the holes 197 of the upright 195 can be teardrop-shaped having an enlarged upper end with a wider dimension and a smaller lower end with a narrower dimension. The wider dimension portion of the surface feature 235 is sized to insert through the wider dimension upper end of the holes 197 and the narrower dimension portion is sized to insert through the narrower dimension lower end of the holes 197. This allows the surface features 235 to engage with the holes 197 by inserting through the upper end of the holes 197 and slide down into the lower end of the holes 197 for fixation relative to the upright 195 because the wider dimension portion of the surface feature 235 is too large to pull through the lower end of the holes 197.

The surface features 235 can be formed by welding separate surface features 235 onto the back surface of the vertical portion 226. Alternatively, the surface features 235 can be punched from the front surface to project outward from the back surface and bent into a proper orientation. FIG. 6E and also FIGS. 9A-9C illustrate an upper surface feature 235a and a lower surface feature 235b projecting from the back surface of the vertical portion 228 that are sized to be received within corresponding upper and lower holes 197 in the upright 195. As mentioned, the holes 197 in the upright 195 can have a teardrop shape having an enlarged upper end and a smaller lower end. The surface features 235 can be inserted through the upper end of the holes 197 and then slid downward to rest within the lower end of the holes 197. The connection between the vertical portion 226 of the second mount component 223 and the upright 195 provided by the surface features 235 can be fixed by an additional fastener 205 that extends through a hole 297 through the vertical portion 226 (See FIGS. 6C-6D). The location of the hole 297 relative to the surface features 235 provides fixation of the vertical portion 226 relative to neighboring holes 197 on the upright. For example, the upper surface feature 235a can project through a first hole 197 in the upright so at least a portion of the surface feature 235a abuts against a lower end region of the first hole 197. The fastener 205 extending through hole 297 of the vertical portion 226 can engage the upright 195 by inserting into a second hole 197 in the upright 195 that is located below the first hole 197. The fastener 205 abuts against an upper end region of the second hole 197. The surface feature 235a abutting against the lower end region of the first hole 197 and the fastener 205 abutting against the upper end region of the second hole 197 provides fixation of the second mount component 223 to the upright 195. The surface features 235a, 235b allow for fast and easy installation of the gate relative to an upright 195.

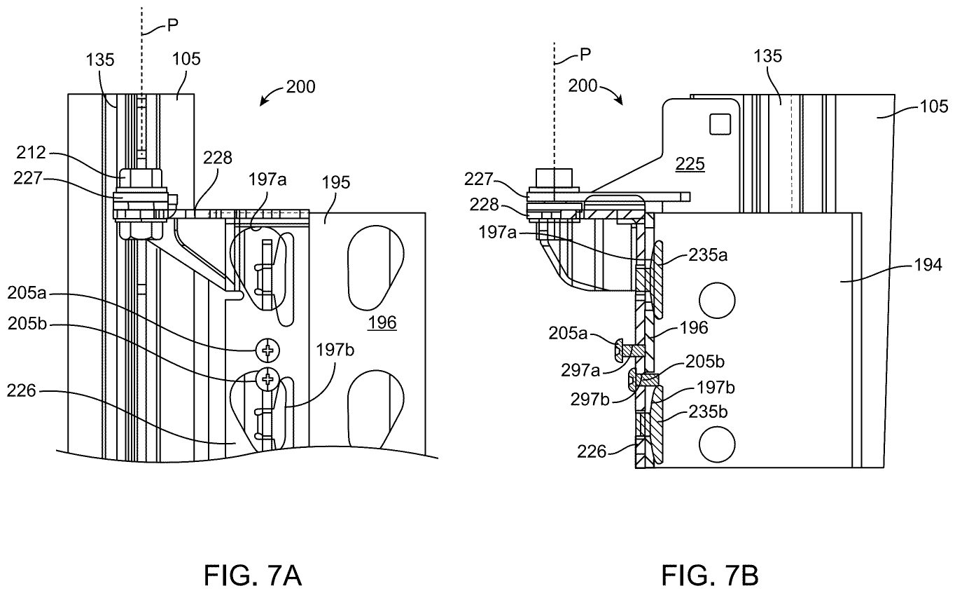

FIG. 7A and also 13A-13B illustrates the bracket assembly 200 of FIG. 5A coupled to a front face 196 of the upright 195. FIG. 7B is a cross-section through the bracket assembly 200 of FIG. 7A. The surface features 235a, 235b extend through adjacent holes 197a, 197b in the front face 196 of the upright 195. The upper fastener 205a extends through an upper hole 297a in the vertical portion 226 of the second mount component 223. The lower fastener 205b extends through a lower hole 297b of the vertical portion 226 of the second mount component 223. However, only the lower fastener 205b extends through and engages with a corresponding hole 197b of the upright 195 fixing the engagement of the vertical portion 226 and the upright 195. The upper fastener 205a is not engaged with any hole 197 of the upright 195.

The bracket assembly 200 shown in FIGS. 7A-7B and also 13A-13B is engaged with the left-side column of holes 197. The bracket assembly 200 is designed universally and can also engage with the right-side column of holes 197. For example, if mounting the gate to extend from the left-side column of holes 197, the bracket assembly 200 can be attached in an upside-up orientation to avoid interfering with the attachments at the right-side column of holes 197. However, if mounting the gate to extend from the right-side column of holes 197, the bracket assembly 200 can be attached in an upside-down orientation to avoid interfering with attachments at the left-side column of holes 197. If, however, there is an obstacle, the gate can be mounted using a different set of holes 197 on the upright 195 and the adjustment mechanism 184 of the footing 175 extended to bridge the greater height (e.g., if mounted higher up along the upright 195) or contracted to accommodate the lesser height (e.g., if mounted lower down along the upright 195).

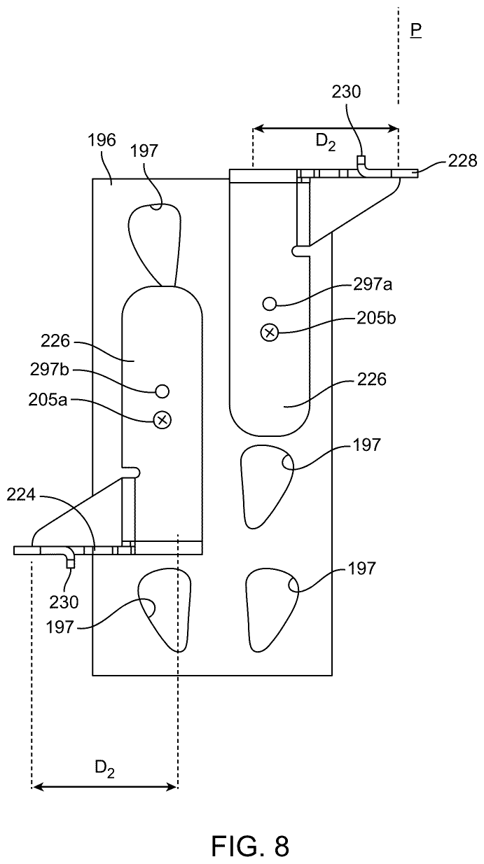

FIG. 8 and also FIG. 13C illustrates two second mount components 223 coupled to an upright 195. One mount component 223 is coupled to the right-side column of holes 197 and a second mount component 223 is coupled to the left-side column of holes 197, but is inverted vertically. The coupling of the surface features 235 and fasteners 205 is universal between the left-side column of holes 197 and the right-side column of holes 197 and still provides a full range of motion from the first articulation position (0 degrees) to the final articulation position (270 degrees) relative to the sides of the upright 195. The surface features 235a, 235b projecting from the backside of the vertical portion 226 (or the holes 297) in other embodiments) are spaced to extend through the adjacent holes 197 in the front face 196 of the upright 195 whether upright and engaged with one column of holes 197 or flipped vertically and engaged with the other column of holes 197. When the vertical portion 226 is engaged with the holes 197 of the upright, the horizontal portion 228 can project away beyond a corresponding side 194 of the upright 195. In the arrangement in FIG. 8, the upright mount component is engaged with the right-side column of holes 197 and the horizontal portion 228 projects beyond the right side 194 of the upright 195 and the inverted mount component is engaged with the left-side column of holes 197 and the horizontal portion 228 projects beyond the left side 194 of the upright 195. The distance D2 between the location of the surface features 235a, 235b (or holes 297) to the location of the pivot axis P where the mount components 221, 223 couple to one another, ensures the pivot axis P is off-set sufficiently away from the side 194 of the upright 195 for full range of pivoting motion around the axis P regardless the column of holes in the upright they are attached to. The first mount components 221 are not shown in FIG. 7, but would be attached to their respective second mount components 223 at the location of the holes 214 as shown in FIGS. 7A-7B and others.

FIG. 8 illustrates the distance D2 for each of the mount components. In some implementations, the distance D2 can be about 1 inch to about 2 inches, preferably about 1.75 inches. The distance D2 allows for the pivot axis P to be off-set sufficiently beyond the plane of the side 194 of the upright 195 for articulation of the expandable section around axis P relative to the side 194 (see off-set O₂ in FIGS. 4B and 5B). Additionally, the pivot axis P is off-set a sufficient distance in front of the front face 194 of the upright 195 (see off-set O₁ in FIGS. 4C and 5C). The off-set O₁ can be about 1 inch to about 1.5 inches, preferably about 1.25 inches.

An example of a common placement for the bracket assemblies 200 described herein is on the last upright 195 at the end of an aisle (e.g., aisle of merchandise in a “big box” store). The upright 195 generally has two columns of holes 197—a left-side column of holes 197 and a right-side column of holes 197. The right-side column of holes 197 of the upright 195 at the end of an aisle may be affixed to a supportive shelf for displaying the merchandise leaving the left-side column of holes 197 at the end of the aisle open for attaching to the bracket assembly 200. If mounting the gate to extend from the left-side column of holes 197, the bracket assemblies 200 can be attached in an “upside-up” orientation to avoid interfering with the attachments at the right-side column of holes 197 of the upright 195. The “upside-up” orientation includes the first mount component 221 located generally superior to the second mount component 223 and the horizontal portion 228 of the second mount component 223 located superior to the vertical portion 226. However, if mounting the gate to extend from the right-side column of holes 197, the bracket assemblies 200 can be attached in an “upside-down” orientation to avoid interfering with attachments at the left-side column of holes 197. The “upside-down” orientation includes the first mount component 221 located generally inferior to the second mount component 223 and the horizontal portion 228 of the second mount component 223 located inferior to the vertical portion 226. If, however, there is an obstacle, the gate can be mounted using a different set of holes 197 on the upright 195 and the adjustment mechanism 184 of the footing 175 extended to bridge the greater height (e.g., if mounted higher up along the upright 195) or contracted to accommodate the lesser height (e.g., if mounted lower down along the upright 195). FIG. 13C is a detail view of a bracket assembly affixed to an upright in an “upside-up” orientation relative to the left-side holes 197 and a bracket assembly affixed to the upright in an “upside-down” orientation relative to the right-side holes 197 on the upright 195.

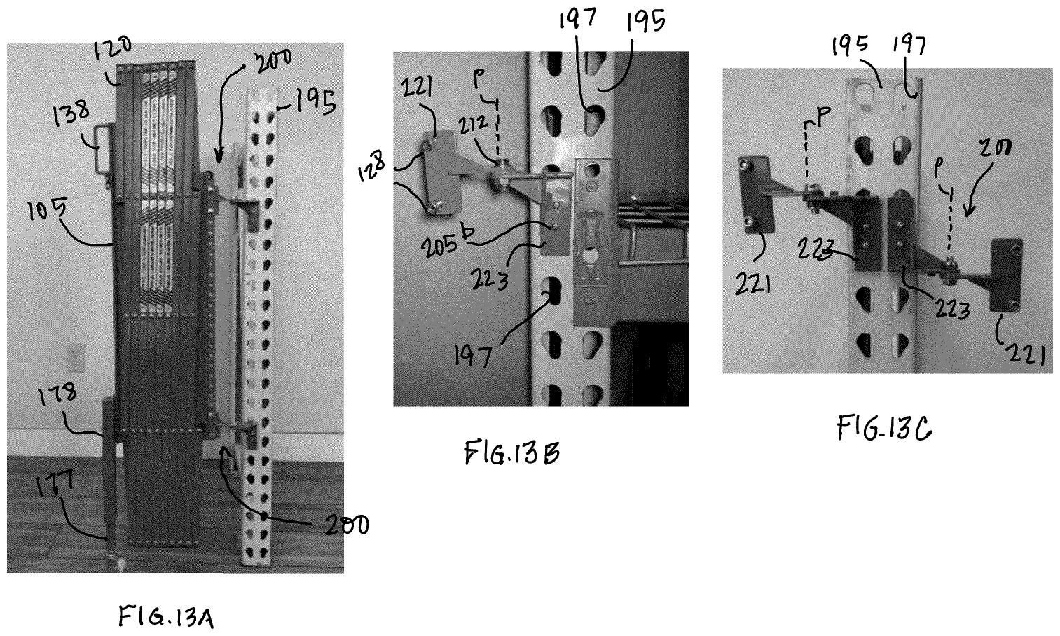

To mount the gate to the upright 195, the vertical portion 225 of the first mount component 221 of an upper bracket assembly 200 and the vertical portion 225 of the first mount component 221 of a lower bracket assembly 200 are spaced away from one another along the inner upright 135 of the gate (see FIG. 14B). Preferably, the upper bracket assembly 200 and lower bracket assembly 200 are spaced along the inner upright 135 of the gate as far apart as possible (e.g., the upper-most set of holes 145 for the upper bracket assembly 200 and the lower-most set of holes 145 for the lower bracket assembly 200). It should be appreciated that more than just an upper and lower bracket assembly 200 may be used to attach the gate to the upright 195. The gate can be placed so the lower end of the compacted slat rest on a support spacer, such as a 6″ long 4×4 piece of wood, so the gate rests a uniform distance from the floor for installation (see FIG. 14A). Once the gate resting on the support spacer is aligned with the upright 195 so that the upper and lower bracket assemblies 200 are aligned with the respective holes 145 of the inner upright 135, the second mount component 223 of each bracket assembly 200 can be engaged with the respective holes 197 of the upright 195 (see FIGS. 14B-14C). The upper and lower surface features 235a, 235b can be dropped into the holes 197 of the upright 195 so that the holes 245a, 245b of the vertical portion 225 of the bracket assembly 200 align with the holes 145 of the inner upright 135. The inner upright 135 can be affixed to the vertical portion 225 of the first mount component 221 of the bracket assembly 200 via fasteners 128 (e.g., bolts, screws, etc.) using a socket wrench and the upright 195 can be affixed to the vertical portion 226 of the second mount component 223 of the bracket assembly via another fastener (see FIG. 14C). For example, a fastener such as a screw can extend through just one hole 297 (e.g., the bottom one of the two holes 297) of the vertical portion 226 of the second mount component 223 and secured to the upright 195 using a screwdriver. The other fastener in hole 297 can be left in place. The surface features 235a, 235b of the bracket assemblies 200 provide a quick installation relative to the holes 197 of the upright because they are capable of being inserted through the wider end of the teardrop shaped holes 197 and slid down into the narrower end of the teardrop shaped holes 197 for immediate fixation. The fixation provided by the surface features 235a, 235b can be fixed in place with a single fastener. The rod 177 can be adjusted for height while maintaining the expandable section of the gate bungie-strapped in its collapsed configuration. The rod 177 can be extended to telescope further outside the receiver element 178 until the wheel 176 is at a distance D just above the surface of the floor (e.g., no greater than about 9.5 mm) as shown in FIGS. 15F-15G.

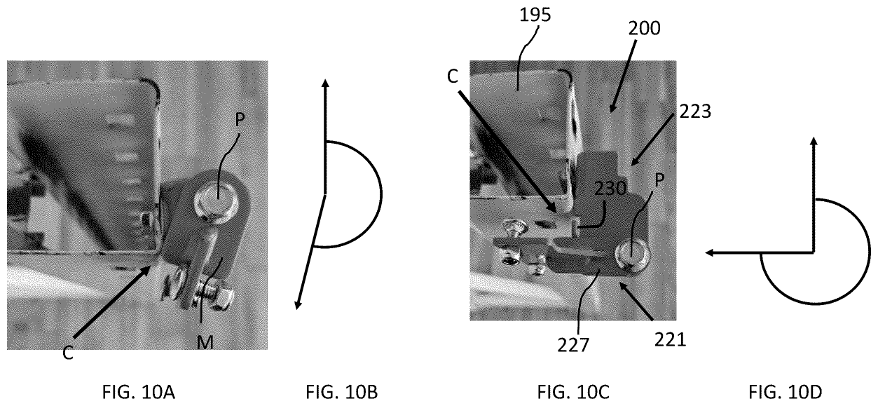

The bracket assemblies 200 described herein allow the gate to rotate around a pivot axis P of the hinge region a full 270 degrees because the pivot axis P of the hinge region is off-set a distance from the corner of the upright to which the bracket assembly 200 is coupled. FIG. 10A shows a bracket assembly in which the horizontal portion of the first mount component M abuts against a corner C of the upright during rotation around the pivot axis P. FIG. 10B shows the angle of rotation is limited to just 195 degrees around the pivot axis P before the first mount component M contacts the corner C of the upright. Contact between the first mounting component M and the upright leads to damage of the gate over time. FIG. 10C shows a bracket assembly as in FIGS. 4A-4C, 5A-5C, 6A-6E, 7A-7B, 8, 9A-9C, and also 11A-11D, 12A-12B, 13A-13C, 14A-14C in which the horizontal portion 227 of the first mount component 221 is capable of articulating 270 degrees around the pivot axis P relative to the second mount component 223 without making contact with the corner C of the upright 195 thereby preventing stress and damage of the gate. The first mount component 221 is prevented from coming into contact at all with the upright 195 in any articulation position around the pivot axis P. At the full articulation position (i.e., 270 degrees around pivot axis P), the first mount component 221 contacts the stop 230 pf the second mount component 223 providing additional impact resistance at the full rotation position, such as if the gate is hit by a shopping cart or other object, that avoids further rotation, stress around the hinge, or damage to the hinge region of the gate.

In various implementations, description is made with reference to the figures. However, certain implementations may be practiced without one or more of these specific details, or in combination with other known methods and configurations. In the description, numerous specific details are set forth, such as specific configurations, dimensions, and processes, in order to provide a thorough understanding of the implementations. In other instances, well-known processes and manufacturing techniques have not been described in particular detail in order to not unnecessarily obscure the description. Reference throughout this specification to “one embodiment,” “an embodiment,” “one implementation, “an implementation,” or the like, means that a particular feature, structure, configuration, or characteristic described is included in at least one embodiment or implementation. Thus, the appearance of the phrase “one embodiment,” “an embodiment,” “one implementation, “an implementation,” or the like, in various places throughout this specification are not necessarily referring to the same embodiment or implementation. Furthermore, the particular features, structures, configurations, or characteristics may be combined in any suitable manner in one or more implementations.

The use of relative terms throughout the description may denote a relative position or direction. For example, “distal” may indicate a first direction away from a reference point. Similarly, “proximal” may indicate a location in a second direction opposite to the first direction. The reference point used herein may be the user such that the terms “proximal” and “distal” are in reference to the user. A region of the device that is closer to the user may be described herein as “proximal” and a region of the device that is further away from the user may be described herein as “distal”. Such terms are provided to establish relative frames of reference, and are not intended to limit the use or orientation of the device to a specific configuration described in the various implementations.

While this specification contains many specifics, these should not be construed as limitations on the scope of what is claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results. Only a few examples and implementations are disclosed. Variations, modifications and enhancements to the described examples and implementations and other implementations may be made based on what is disclosed.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.”

Use of the term “based on,” above and in the claims is intended to mean, “based at least in part on,” such that an unrecited feature or element is also permissible.

What is claimed is:

1. A bracket assembly for attaching an expandable barrier to an upright, the bracket assembly comprising:
a first mount component coupled to a second mount component forming a hinge region having a pivot axis, wherein the first mount component is configured to couple to the expandable barrier and the second mount component is configured to couple to the upright, and
wherein the pivot axis of the hinge region is off-set a distance from the upright sufficient to articulate the expandable barrier around the pivot axis from a first position in which the expandable barrier lies substantially within a plane that is parallel to a plane of a first side of the upright to a second position in which the expandable barrier lies substantially within a plane that is parallel to a plane of a second side of the upright.

2. The bracket assembly of claim 1, wherein the first mount component comprises a first vertical portion coupled to a first horizontal portion defining a first hole extending through its full thickness.

3. The bracket assembly of claim 2, wherein the second mount component comprises a second vertical portion and a second horizontal portion defining a second hole extending its full thickness, wherein the first hole and the second hole align to receive a pin therethrough forming the hinge region, the pivot axis extending through the pin.

4. The bracket assembly of claim 3, wherein the second vertical portion comprises surface features sized and shaped to engage the upright.

5. The bracket assembly of claim 4, wherein the surface features project outward from a surface of the second vertical portion.

6. The bracket assembly of claim 5, wherein the surface features are punched out and bent to project outward from the surface.

7. The bracket assembly of claim 5, wherein the surface features are welded onto the surface of the second vertical portion.

8. The bracket assembly of claim 2, wherein the first mount component is coupled to the second mount component to rotate less than 360 degrees around the pivot axis.

9. The bracket assembly of claim 8, wherein the first mount component is coupled to the second mount component to rotate greater than 0 degrees up to about 270 degrees around the pivot axis.

10. The bracket assembly of claim 9, wherein the horizontal portion of the second mount component incorporates a first stop on an upper surface and a second stop.

11. The bracket assembly of claim 10, wherein the first stop abuts against an edge of the horizontal portion of the first mount component preventing rotation in a first direction around the pivot axis.

12. The bracket assembly of claim 11, wherein the second stop abuts against a surface of the vertical portion of the first mount component preventing rotation in a second, opposite direction around the pivot axis.

13. The bracket assembly of claim 11, wherein the first stop defines a boundary of the first articulation position that is 0 degrees around the pivot axis.

14. The bracket assembly of claim 12, wherein the second stop defines a boundary of the final articulation position that is 270 degrees around the pivot axis.

15. The bracket assembly of claim 1, wherein the second mount component is configured to couple to the upright in both an upright position and an inverted position.

16. A system comprising the bracket assembly of claim 1 and further comprising the expandable barrier.

17. The system of claim 16, wherein the expandable barrier comprises an expandable section coupled to an inner upright on a first side and coupled to an outer upright on a second side, and a footing on a lower end of the expandable section, wherein the expandable section comprises a multiplicity of slats hingedly interconnected in a scissoring lattice-type structure configured to expand outward from a compact, collapsed narrow configuration to an expanded, wide configuration.

18. The system of claim 17, wherein the footing is adjustable in height via a telescoping spring button lock mechanism.

19. The system of claim 17, wherein the outer upright comprises a hollow receiver element comprising a channel extending through at least a portion of its length, the hollow receiver element comprising one or more apertures through one or more walls of the receiver element into the channel, and wherein the footing comprises a rod extending upwardly and configured to be received into and coupled to the lower end region of the channel in the hollow receive element of the outer upright, wherein the footing is coupled to the outer upright by a height adjustment feature configured to change a height of the footing relative to the outer upright.

20. The system of claim 19, wherein the rod comprises a spring button sized and shaped to mate with and extend through the one or more apertures in the receiver element, wherein the spring button is biased outward to project through the one or more apertures.

21. The system of claim 17, wherein the multiplicity of slats are steel or plastic.

22. The system of claim 17, wherein the multiplicity of slats have a cross-sectional shape that is square, rectangular, circular, or oval.
